(19) United States
(12) Patent Application Publication
(10) Pub. No.: US 2012/0181161 A1
(43) Pub. Date: Jul. 19, 2012

(54) METHOD FOR THE PRODUCTION OF BIOETHANOL AND FOR THE COPRODUCTION OF ENERGY FROM A STARCHY PLANT STARTING MATERIAL

(76) Inventor: John Mahler, London (GB)

(21) Appl. No.: 12/301,494

(22) PCT Filed: Jul. 3, 2007
(86) PCT No.: PCT/EP07/56667

§ 371 Date: Jun. 24, 2009

(30) Foreign Application Priority Data
Jul. 3, 2006 (FR) 0652767

(51) Int. Cl. B01D 3/00

(52) U.S. Cl. 203/39

(57) ABSTRACT

A method includes at least the following successive steps: A) preparing a paste (must) includes the starchy plant starting material (MPV) capable of being fermented; B) bringing about the fermentation of said paste with a view to obtaining a fermented mixture (MF); D) distilling said fermented mixture (MF), at least in part, so as to obtain bioethanol and light vinasse (VL); E1) producing at least a first fuel for the coproduction of energy, in particular thermal energy, using at least a part of the light vinasse. The method comprises a step C1) of separating, by filtration and pressing, the liquid phase (PL) and the solid phase (PS) from the fermented mixture involved before the distillation

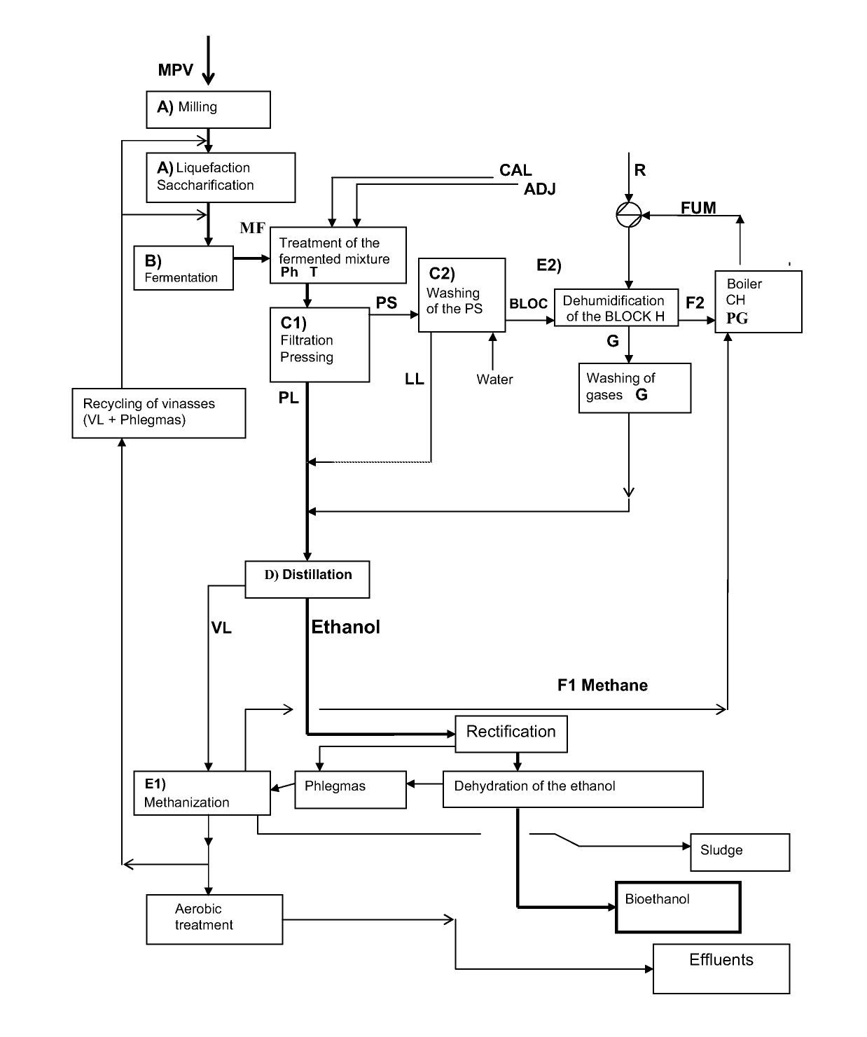

### TECHNICAL FIELD OF THE INVENTION

The present invention relates to a method for the production of bioethanol and for the coproduction of energy from a plant starting material.

The objective of the invention is in particular to produce, on an industrial scale, bioethanol from starchy plants with cogeneration or coproduction of energy using the biomass of the plant, just like the production of bioethanol from sugar cane, which uses the bagasse of the plant.

This method can be used not only for new bioethanol distilleries, but also in existing distilleries, by adapting the existing plants.

Among the various methods for producing bioethanol from a plant starting material, three groups stand out: a) sacchariferous resources, such as sugar beet, sweet stems such as sugar cane or sorghum, fruits; b) starchy resources such as corn or wheat grains, and c) lignocellulosic resources.

### TECHNICAL BACKGROUND

Depending on the starting plant material, the method for producing bioethanol generally comprises three major principal operation groups, i.e., consecutively A) the preparation of a must, then B) the fermentation of the must with a view to obtaining a fermented must, then D) the distillation of the fermented must with a view to the production of bioethanol.

It is possible to add, to these three major operation groups, a fourth general group E) of operations which consist of various treatments of the coproducts resulting from each of these three principal operation groups.

All the operations A) for preparing the must are aimed at preparing a paste or a juice comprising plant starting material able to be fermented, i.e. an aqueous solution of sugars that can be fermented by yeasts, while aiming to obtain as high a concentration as possible so as to reduce the volumes of the equipment necessary for the preparation of the must and for the other subsequent operations, while at the same time taking into account the limitation of the possible production of fermentation inhibitors.

In the case of production from sacchariferous resources, the specific step of preparing the must consists of extraction of the sucrose, for example by pressing, or washing with hot water according to known techniques for directly obtaining a highly fermentable juice.

In the case of production from starchy resources, it is generally first necessary to convert the grain to soluble and fermentable sugar, for example, according to the starch conversion techniques which are, for example, known in the starch production industry, or else according to the “acid process” techniques.

The fermentation B) is based on the activity of microorganisms, the fermentative metabolism of which results in their incomplete oxidation to ethanol and to CO₂.

The performance levels of the fermentation operations essentially depend on the microorganism used (or on the microorganisms used), on the culture medium on which the microorganism acts and on the method used. The yield in terms of alcohol, or ethanol, depends on the control of these various parameters.

It is essentially yeasts that are used industrially for the production of bioethanol.

The composition of the culture medium, using the must, essentially aims to provide the microorganism used with the optimum conditions for its metabolism and the production which is demanded of it.

The fermentation technologies used are diverse and known, and progress in the fermentation field is essentially aimed at improving the general cost-effectiveness thereof both in terms of productivity and conversion rate, by making use, for example, of yeasts, specific enzymes, etc.

In order to obtain a fermented mixture (MF) from the plant starting material (MPV), the steps or operations A) and B) can be grouped together and/or replaced with other methods for producing a fermented mixture (MF).

The distillation techniques D) used are themselves also entirely known, for example those used in the distillation of alcoholic solutions, and they differ from one another only by virtue of the distillation scheme and the optimization of the energy balances in correlation with the energy needs of each operation.

It will, however, be recalled that the cost of distillation is directly linked to the ethanol content, to the quality of the distilled product and to energy consumptions, and that constant efforts are therefore necessary in order to have a fermented must with a high ethanol content.

The various operations E) for treating the coproducts which result from the three principal operation groups described above have a considerable impact, both in terms of the economics of the various methods of bioethanol production, and in terms of the “environmental” aspects.

Whatever the plant starting material resource used, all the methods result in the production of CO₂ and of biomass, as coproducts.

In the case of a method based on sacchariferous resources, for example based on sugar cane or on sugar beet, the glucose contained in the plant, which is obtained by milling or by pressing or washing with hot water, is directly fermentable and the vinasses derived from the fermentation are rich in organic materials (+/−80%) and in mineral materials (+/−20%) which pose problems for their elimination.

In the case of sugar cane, the bagasse, which constitutes the biomass remaining in the mills after extraction of the sugary juice, can be burned for the coproduction of energy and its combustion covers the heat and electricity needs of the bioethanol production units, due to the calorific value of this type of biomass.

In the case of a method based on starchy resources, the starch contained in the grain must first be converted to fermentable sugar(s), for example by implementing the enzymatic method, the acid method or the malt method.

Thus, the “raw” vinasse obtained after distillation comprises essentially water and biomass with yeasts produced during the fermentation. The digestibility makes it possible to make in particular a nutritional supplement therefrom.

Thus, after separation of the solid fraction of the vinasse, for example by centrifugation and then by dehumidification and concentration of the liquid fraction of the vinasse, the “DDGS” (Distiller Dried Grain with Soluble) product is obtained, which is used in particular for animal feed.

The vinasse may also be used for the production of fertilizing agents, or it may also be converted to energy.

Attempts have been made to burn the vinasse after concentration, or by sending it to reactors to produce methane gas.

However, the technical problems encountered—such as, for example, clogging or blocking of boiler tubes—have not enabled such types of vinasse treatments to be implemented cost-effectively on the industrial scale.

All the known methods for producing bioethanol from starchy and sugary plants thus exhibit an economic, and in particular an energy balance, that are still insufficient, and also a very negative environmental balance.

A method for producing fuel alcohol from fermented plants “without vinasse” has been proposed in document U.S. Pat. No. 4,337,123 from 1982.

This method proposes, after fermentation and before distillation, to implement a treatment during which several substances contained in the fermented must are removed in such a way that the distillation means are fed with a “purified” juice so that the distillation step produces only alcohol and does not produce vinasse.

The method described in this document thus makes use of a treatment by chemical precipitation, in particular by the addition of a flocculating agent, and then of a decanting operation.

Such a method is particularly complex to implement and expensive, and it provides in particular no favorable energy balance while at the same time requiring the use of new additional products in order to obtain the chemical precipitation.

The unfavorable energy balance is in particular due to the fact that all the “solid” products separated by decanting comprise a proportion of solids which is highly insufficient for their subsequent combustion to be of sufficient yield, i.e. the drying operations prior to this combustion require the input of too great an amount of external fossil energy. In other words, the water content of all the “solid” products separated by decanting (or solid phase) is too high for the method to have a satisfactory energy balance.

Document EP-A2-0.048.061, from 1981, proposes a method and an apparatus for treating the vinasse in the context of a general method for producing alcohol from sugar cane, with a view to optimizing the overall energy balance of the alcohol-producing method. This method proposes concentrating solids and soluble materials contained in the vinasse, and then burning them so as to obtain vapor which is re-used in various forms, in particular in the method for producing alcohol.

The combustion of the concentrated vinasse is very difficult and must be carried out in boilers which are very complex and expensive, similar to the boilers that are used in the cellulose industry to burn the concentrated black liquor.

Document WO-A1-2004/113549 (Wilkening) has proposed methods for producing ethanol and methane from the biomass, the performance levels of which are improved by controlling and modifying the parameters of the biomass used. One of the methods consists, as a variation, prior to the fermentation or to the distillation, in separating from the biomass the proteins which are present therein, and also the bran which might be present therein. This document does not provide an effective industrial solution for carrying out the separation. Thus, this method does not make it possible to treat all the plant starting material, and its overall efficiency is insufficient.

### SUMMARY OF THE INVENTION

The present invention aims to propose a novel method for the production of bioethanol and for the coproduction of energy, from a starchy plant starting material, and which is characterized essentially in that it comprises a step, occurring before distillation, filtration, washing and pressing, which makes it possible to separate the liquid phase from the solid phase of the fermented must.

The invention thus proposes a method for the production of bioethanol and for the coproduction of energy from a starchy plant starting material MPV, characterized in that it comprises at least the following successive steps consisting in:
A)-B) obtaining, from all of the plant starting material (MPV), a fermented mixture (MF);
C1) separating, by filtration and pressing, the liquid phase (PL) and the solid phase (PS) from the fermented mixture (MF), in such a way that the proportion by weight of the solids of said solid phase (PS) is between approximately 40% and approximately 45%;
D) distilling, at least in part, said liquid phase (PL) of said fermented mixture (MF) so as to obtain ethanol and light vinasse (VL);
E1) producing, using all of said light vinasse (VL), methane gas (F1) constituting a first fuel for the coproduction of energy;
   and in that, prior to said separation step C1), the method comprises:
   a step during which the pH of said fermented mixture (MF) is increased so as to be brought to a value of between approximately 5.5 and approximately 6.5;
   and a step during which a filtration adjuvant (ADJ) is added to said fermented mixture (MF).

Said step E1) of producing at least a first fuel consists in producing methane gas from all of the light vinasse VL, and optionally from phlegmas originating from rectification and dehydration of the ethanol.

By virtue of the invention, it is possible to obtain a biomass which is burned to produce energy, and the calorific value of which is similar to that of bagasse and, as in the case of alcohol produced from sugar cane, virtually without the need to make use of an external fossil energy.

Furthermore, the qualities of the light vinasse obtained after distillation are such that they make it possible to produce methane under optimal yield conditions.

In fact, the light vinasse VL has a low nitrogen content because the nitrogen, present in the starchy plant starting material and in the yeasts used for the fermentation, has been to a large extent removed by virtue of the operation of separating the liquid and solid phases before the distillation. This methanization is particularly advantageous and efficient insofar as the liquid phase has a low nitrogen content, nitrogen being an inhibitor of methanization.

After methanization, the liquid phase thus obtained may undergo a supplementary treatment resulting in the production of water that can be re-used in the implementation of the method according to the invention, or discarded into the natural environment. The quality of this water corresponds to the strictest environmental requirements and standards. The methanization also produces a small amount of sludge which, after drying, can, for example, constitute soil enrichment products.

Supplementary treatments make it possible to re-use the water in the context of the implementation of the method according to the invention, by virtue of the very small amount of pollutant loads at the output from methanization.

According to another characteristic of the method according to the invention, it comprises a step E2) of producing at least a second fuel, which consists in dehumidifying said solid phase PS of the fermented mixture MF so as to produce a block of material, of which the proportion by weight of solids is greater than 50%, said block being capable of being burned, entirely or in part, in a boiler, and/or said block being capable of being used, entirely or in part, for the production of a product (DDGS) used in particular for animal feed.

Said solid phase PS of the fermented mixture MF is, for example, dehumidified by drying.

However, this drying operation requires only very little energy which may for example be made up of the thermal energy contained in the flue gases FUM from the boiler. The drying does not therefore require any external fossil energy, nor any vapor produced in the context of the method according to the invention, and the calorific value of the “dried” block is thus further increased very economically from the point of view of the overall energy balance of the method.

The gases (G) emitted by the solid phase during the drying are treated so as to extract, entirely or in part, the ethanol that these gases contain, by means of methods including, but not limited to, washing the gases with water, passing the gases over an active carbon, etc.

The yield of the method in terms of ethanol production is thus further increased.

According to another characteristic of the method according to the invention, said first fuel constituted by the methane, entirely or in part, and said second fuel (the block of material obtained from the solid phase), entirely or in part, are burned in the same boiler. This allows better combustion of the block, or “cake”, while using a combustion chamber of smaller dimensions.

According to another aspect of the invention, the very high efficiency of step C1) of separating the liquid phase PL and the solid phase PS from the fermented mixture MF, allowing the proportion by weight of solids in said solid phase (PS) to be between approximately 40% and approximately 45%, is advantageously obtained in that said separation step C1) is carried out by means of a filter press adapted for this purpose.

Still for improving the performance levels of the process for separating the liquid and solid phases, i.e. for increasing the ability of the fermented mixture to be filtered:
prior to said separation step C1), the method comprises a step during which the temperature of the fermented mixture is brought to a separation temperature T of between approximately 55° C. and approximately 65° C.;
the pH of the fermented mixture (MF) is, for example, increased by adding at least one alkaline component.

The method comprises an intermediate step C2) of washing said solid phase separated from the fermented mixture, so as to recover as much of the residual ethanol contained in the solid phase as possible.

This step C2) of washing the solid phase PS separated from the fermented mixture is advantageously carried out by injecting washing water into the filter press in such a way that at least a part of the washing liquid LL very rich in ethanol is automatically added to the liquid phase of the fermented mixture to be distilled.

The method according to the invention makes it possible, industrially, to simultaneously produce bioethanol and energy, in particular due to the controlling of the proportion of solids in the solid phase and due to the quality (virtual absence of solids in suspension) of the liquid phase before distillation.

### BRIEF DESCRIPTION OF THE FIGURE

Other characteristics and advantages of the invention will emerge on reading the description which follows, given by way of nonlimiting example, for the understanding of which reference will be made to the attached drawing in which the single FIGURE is a scheme illustrating an example of a method according to the invention.

### DETAILED DESCRIPTION OF THE FIGURES

An exemplary embodiment of the principle of separation/filtration, according to the invention, of the liquid and solid phases which is applied here to the fermented must before distillation, will now be described with reference to the single FIGURE.

The starchy plant starting material MPV undergoes, for example, a first step A of preparing a must.

It involves, for example, when the plant starting material MPV is a cereal, substeps of milling the cereals, and then of saccharification and liquefaction of the milled mixture.

The plant starting material MPV may consist directly of grains such as corn or wheat, the milling then resulting in the preparation of a flour which is itself prepared with a view to obtaining the must.

The must is thus a paste produced from the plant starting material MPV which is capable of being fermented.

The method subsequently comprises a step B of fermenting the must with a view to obtaining a fermented mixture MF capable of being distilled, also called fermented must MF.

In a known manner, carbon dioxide CO₂ is coproduced from such a fermentation step B.

The method subsequently comprises the distillation step D for obtaining the bioethanol, i.e. the principal product of the method comprising the successive steps A, B and D, and also a coproduct called vinasse which is a mixture, in particular rich in water.

At the end of fermentation step B, the fermented must MF undergoes immediately, i.e. before the distillation D, and during an intermediate operation C1, an operation of physical separation of the liquid phase PL and of the solid phase PS from the fermented must MF.

The liquid phase PL of the fermented must MF is sent to the distillation, i.e. it undergoes distillation step D resulting in the production of bioethanol and in the production of a liquid coproduct, herein referred to as the light vinasse VL.

The fact that, in accordance with the teachings of the invention, the distillation operation is applied to only the liquid phase PL of the fermented must MF means in particular that equipment of smaller dimensions and volumes is used compared with conventional mixed, liquid and solid, two-phase operations for the distillation of a product.

The separation of the liquid phase PL from the fermented must MF is obtained mechanically by filtration and pressing, preferably by means of a filter press, and/or, as a variant, by means of a filter and of a press operating continuously or in batch mode.

These first physical operations resulting in the separation of the liquid phase PL and of the solid phase PS from the fermented must are designated by step C1 in the FIGURE.

The quality of the separation carried out according to the invention depends on the capacity or ability of the fermented mixture MF to be filtered.

This ability may, for example, be expressed in the form of the “CST” parameter which is measured according to normalized methods well known to those skilled in the art.

In the context of the present invention, it has been discovered that the control and/or the modification of certain parameters of the fermented mixture obtained from the starchy starting material considerably increases this ability to be filtered, and therefore the proportion by weight of the solids obtained.

The first of these parameters is the temperature T, herein termed filtration temperature, of the mixture when it is introduced into the separation means used, and for example into a filter press.

Thus, prior to the separation step, the method comprises a step during which the temperature of the fermented mixture MF is brought to or maintained at a separation temperature T which is between approximately 55° C. and approximately 65° C. This controlling of the separation temperature T can result directly from the prior steps of treating the starting material for the purposes of obtaining the fermented mixture, and can, for example, be obtained without the consumption of additional energy, since the fermented mixture must in any case be brought to 65° C. before distillation.

The second of these parameters is the pH of the mixture when it is introduced into the separation means used.

Thus, prior to the separation step, the method comprises a step during which the pH of the fermented mixture MF is increased so as to be brought to a value of between approximately 5.5 and approximately 6.5. For example, the pH of the fermented mixture MF is increased by adding at least one alkaline component including, but not limited to, calcium carbonate CaCo₃ or calcium hydroxide Ca(OH)₂.

Furthermore, it is noted that these two parameters (temperature T and pH) are linked as regards the ability of the fermented mixture to be separated, i.e. it is possible to establish a series of curves indicating the value of the CST as a function of the temperature T, and for a given pH value (or vice versa).

In addition, the values of these parameters depend on the starchy starting material used.

It is also possible to improve the ability of the mixture to be filtered by making use of a filtration adjuvant ADJ, for example a polymer-based adjuvant.

The solid by-products resulting from the physical separation in C1 can undergo, as illustrated herein, a substep C2 of washing the separated solid products.

The washing is carried out, for example, by injection of washing water into the filter press, with at least the same temperature as that of the fermented mixture MF. After washing, the washing water is referred to as washing liquid LL and this washing liquid is reused in the following way.

The washing liquid LL having a high ethanol content is reused entirely or in part by being mixed with the liquid phase PL of the fermented must MF before the distillation D.

In the case of the use of the filter press, this “mixing” is automatic at the “outlet” of the filter press.

A part of the ethanol contained in the solid phase PS is thus recovered. The recovery of this ethanol at a subsequent stage would be more complex and expensive.

In accordance with the method according to the invention for the production of bioethanol and for the coproduction of energy, the light vinasse VL subsequently undergoes a step E1 of producing a first fuel F1, which herein is methane.

This step E1, referred to as methanization step, is thus applied to light vinasse VL, the qualities of which are optimal in this regard, in particular in that the vinasse contains virtually no solid component in suspension.

The production of the methane gas or biogas is, for example, obtained by anaerobic treatment. Methane is obtained by acidogenesis and methanogenesis, said methane constituting the first fuel F1 obtained according to the method of the invention, which can subsequently be used, in a step PG, for coproducing energy.

The production of methane gas is obtained by methanization, from the liquid vinasse—referred to as light vinasse VL—derived from the distillation and also from the “phlegmas” FG resulting from the known steps of rectification and dehydration of the ethanol after the distillation step.

The light vinasse VL has a low nitrogen content because the nitrogen, present in the starchy plant starting material and in the yeasts used for the fermentation, has been to a large extent removed by virtue of the operation of separating the liquid and solid phases before the distillation. This methanization is particularly advantageous and efficient insofar as the liquid phase has a low nitrogen content, nitrogen being an inhibitor of methanization.

During the PG step, equipment including, but not limited to: a generator; a boiler; a gas turbine; a motor, fed with methane, can produce energy including, but not limited to: electricity; steam; hot water, etc.

In the example illustrated in the single FIGURE, the methane F1 is burned in a boiler which is, for example, a boiler for the production of steam. The boiler also produces residual flue gases FUM.

A very efficient cycle of coproduction of energy from the fuel derived from the light vinasse VL is thus provided.

The liquid effluents produced during the gasification (methanization) step E1 can be treated, during one or more treatment steps, via a supplementary aerobic pathway, among other things in order to obtain a purified liquid effluent and/or water that can be reused in the method according to the invention.

In the context of the coproduction, or cogeneration, of energy according to the method according to the invention, the solid phase PS of the fermented must MF, i.e. the residual materials originating from the fermentation B, is itself also readily converted to energy.

Due to the technique of separating by filtration and pressing, in particular in a filter press, the proportion by weight of solids of the solid phase PS obtained is greater than 40% by weight, and is for example between approximately 40% and approximately 45%.

Step E2, of producing the second fuel, is a dehumidification step, for example by drying and/or by any other suitable physical process, which consists in dehumidifying the solid phase PS of the fermented must MF so as to produce a dried block F2, also called “cake”, which is then a combustible element that can be readily burned.

This is because the dehumidification step makes it possible to have a combustible block, the solids content of which is then greater than 50%, i.e. a level which allows good combustion.

The block thus constitutes, for the purpose of the invention, the second combustible product F2 for the coproduction of a second energy during a second step for coproducing energy.

This fuel F2 can thus, for example, be burned in a boiler which produces energy including, but not limited to: electricity; steam; hot water, etc.

This fuel F2 is here preferably burned in a boiler which is here the same boiler CH as that in which the methane F1 is burned.

The means used for the coproductions PG of energy also give off flue gases FUM and/or gases which can be recovered during a step R and which can in particular be used as a source of energy during the step E2 of dehumidification of the solid phase.

The heat contained in these flue gases is recovered by means of an exchanger. This drying energy is thus economical because it is recovered without it being necessary to call on vapor produced by the boilers in the context of the method, or on external fossil energy.

It will also be noted that this step results in the production of ash.

By virtue of the two steps E1 and E2 of producing the two fuels F1 and F2 which are subsequently converted to energy, the method according to the invention is a method for the production of bioethanol and for the coproduction of energy PG, since not only can the production of bioethanol be “self-sufficient” in terms of energy, but the method results in the coproduction of an excess of energy which can be marketed in the forms including, but not limited to, steam, hot water, electricity, etc.

The combustion of the high-solids-content solid phase PS can be carried out with ease in a biomass boiler, if one compares this combustion with all the previous attempts at combustion of concentrated vinasses, without prior separation of the solid and liquid phases.

The residues from the combustion of the two fuels, or from the combustions if they are carried out separately, can be marketed after drying, for example in the form of soil enrichment products.

Depending on various parameters, and in particular on the plant starting material MPV used, the liquid phase PL can be used entirely or in part for the purpose of producing the methane F1.

Similarly, the solid phase PS can be used entirely or in part for the purpose of producing the solid fuel or block F2, and/or it can be used entirely or in part for the production of DDG (Distiller Dried Grain) which is used in particular for animal feed.

This DDG is of a much higher quality than that which is currently available. The residual ethanol content is very low.

This very low residual content results first from the separation technique used.

The ethanol content of the block F2 is further reduced by virtue of a step C2) of washing the solid phase PS separated from the fermented mixture MF.

If the washing is carried out outside the filtration and pressing means, the washing liquid can be entirely or in part reused by being mixed with the must upstream of the fermentation step B. It is thus possible to mix the liquid with the must before the fermentation step and/or to use it for the preparation step. A saving is thus in addition made in terms of a part of the water used for the preparation and/or the fermentation.

A separation of the washing liquid, after washing, into two distinct pathways can be carried out according to the ethanol content of the washing liquid.

Advantageously, when the separation of PL and of PS is carried out by means of a filter press, the substep C2) of washing the solid phase PS separated from the fermented mixture MF is carried out by injection of washing water into the filter press in such a way that at least a part of the washing liquid with an ethanol content is then “automatically” added to the liquid phase PL of the fermented mixture to be distilled.

The ethanol content of the combustible block F2 is further reduced during the step of dehumidification by drying, which causes evaporation, in the form of gas G, of the liquid material that it contains, and in particular the ethanol, which is then in the form of alcohol vapors.

This “vaporized” ethanol can itself also be recovered, for example with a step of washing the gases G, for example by means of water.

1-13. (canceled)

14. A method for the production of bioethanol and for the coproduction of energy from a starchy plant starting material (MPV), characterized in that it comprises at least the following successive steps consisting in:
A)-B) obtaining, from all of the plant starting material (MPV), a fermented mixture (MF);
C1) separating, by filtration and pressing, the liquid phase (PL) and the solid phase (PS) from the fermented mixture (MF), in such a way that the proportion by weight of the solids of said solid phase (PS) is between approximately 40% and approximately 45%;
D) distilling, at least in part, said liquid phase (PL) of said fermented mixture (MF) so as to obtain ethanol and light vinasse (VL);
E1) producing, using all of said light vinasse (VL), methane gas (F1) constituting a first fuel for the coproduction of energy;
and in that, prior to said separation step C1), the method comprises:
a step during which the pH of said fermented mixture (MF) is increased so as to be brought to a value of between approximately 5.5 and approximately 6.5;
and a step during which a filtration adjuvant (ADJ) is added to said fermented mixture (MF).

15. The method as claimed in claim 14, characterized in that said separation step C1) is carried out by means of a filter press.

16. The method as claimed in claim 14, characterized in that, prior to said separation step C1), the method comprises a step during which the temperature of said fermented mixture (MF) is brought to a separation temperature (T) of between approximately 55° C. and approximately 65° C.

17. The method as claimed in claim 15, characterized in that, prior to said separation step C1), the method comprises a step during which the temperature of said fermented mixture (MF) is brought to a separation temperature (T) of between approximately 55° C. and approximately 65° C.

18. The method as claimed in claim 14, characterized in that the pH of said fermented mixture (MF) is increased by adding at least one alkaline component (CAL).

19. The method as claimed in claim 14, characterized in that it comprises a substep C2) of washing said solid phase (PS) separated from said fermented mixture (MF).

20. The method as claimed in claim 15, characterized in that it comprises a substep C2) of washing said solid phase (PS) separated from said fermented mixture (MF).

21. The method as claimed in claim 21, characterized in that said step C2) of washing the solid phase (PS) separated from the fermented mixture (MF) is carried out by injection of washing water into the filter press in such a way that at least a part of the washing liquid (LL) having an ethanol content is automatically added to said liquid phase (PL) of the fermented mixture to be distilled.

22. The method as claimed in claim 14, characterized in that said separation step C1) is carried out by means of said fermented mixture (MF) so as to produce a block (F2) of material of which the proportion by weight of between approximately 55° C. and approximately 65° C.

23. The method as claimed in claim 22, characterized in that said solid phase (PS) of said fermented mixture (MF) is dehumidified by drying (H), and in that the gases (G) emitted during the drying are processed so as to extract, entirely or in part, the ethanol that these gases contain, in particular by washing the gases with water.

24. The method as claimed in claim 23, characterized in that said methane (F1), entirely or in part, and said second fuel (F2), entirely or in part, are burned in the same boiler.

25. The method as claimed in claim 14, characterized in that said fermented mixture (MF) is obtained by means of the successive steps consisting in:
A) preparing a paste comprising the plant starting material (MPV) capable of being fermented;
B) bringing about the fermentation of said paste with a view to obtaining the fermented mixture (MF).
